(19) United States
(12) Patent Application Publication
(10) Pub. No.: US 2024/0058865 A1
(43) Pub. Date: Feb. 22, 2024

(54) HIGH DENSITY ALUMINUM PARTS FROM ADDITIVE MANUFACTURING

(71) Applicant: ExOne Operating, LLC, North Huntingdon, PA (US)

(72) Inventors: Patrick DOUGHERTY, Pittsburgh, PA (US); Deborah M. WILHELMY, Greensburg, PA (US); Kyle MYERS, Jeannette, PA (US)

(21) Appl. No.: 18/260,324

(22) PCT Filed: Jan. 4, 2022
(86) PCT No.: PCT/US2022/011060

§ 371 Date: Jul. 4, 2023

Related U.S. Application Data
(60) Provisional application No. 63/133,750, filed on Jan. 4, 2021.

(51) Int. Cl. B22F 10/14; C22C 21/06; B33Y 10/00; B22F 10/64; B33Y 40/20; B33Y 70/00

(52) U.S. Cl. CPC B22F 10/14; C22C 21/06; B33Y 10/00; B22F 10/64; B33Y 40/20; B33Y 70/00; B22F 2201/02; B22F 2304/10; B22F 2998/10; B22F 2999/00; B22F 2301/052; B22F 2301/30

(57) ABSTRACT

A process for producing a high density aluminum alloy part from a green part like those produced by binder jet additive manufacturing is described. The process utilizes a build powder that includes a densification aid mixed with the aluminum alloy powder and gets incorporated into the green part during the printing process. In some cases, a continuous high flow of nitrogen gas and controlled heating of the green part and provides a high density aluminum alloy part exhibiting densities of 95% or greater.

This is a U.S. national stage of application, filed under 35 U.S.C. § 371 of International Patent Application No. PCT/US2022/011060, filed on Jan. 4, 2022, which claims priority under from U.S. Patent Application No. 63/133,750, filed on Jan. 4, 2021; the disclosures of which are incorporated herein by reference.

### FIELD

The present disclosure is generally directed to the production of high density aluminum parts. More particularly, the present disclosure is directed to additively manufacturing high density aluminum parts from a binder jet printing process.

### BACKGROUND

When it comes to delivering a more fuel-efficient and sustainable future, aluminum is widely regarded as a key part of the solution. Aluminum is lightweight, strong, highly recyclable and can therefore help lower energy costs and carbon emissions in automobiles, airplanes, military equipment and more. However, shaping higher strength aluminum alloys into lightweight designs with a manufacturing technology that is sustainable itself and fast enough for serial production has been elusive.

The traditional methods of manufacturing aluminum parts, such as metal casting and machining, each present limitations on the types of geometries that can be produced as well as the specific aluminum alloys that can be easily shaped into a part. Each aluminum alloy contains its own properties for items such as strength-to-weight ratio, weldability, energy absorption, and resistance to corrosion, cracking and heat. Generally, the higher the strength of aluminum, the more difficult and expensive it is to form.

Traditional methods of manufacturing aluminum are generally not regarded as sustainable themselves generating waste, emissions and preventing the formation of the most innovative designs that deliver the best sustainability benefits in terms of weight reduction and performance.

The emergence of metal additive manufacturing, also known as 3D printing, in the early 1990s with laser powder bed fusion (LPBF) presented a lower waste method of producing new geometries in a range of metals, including certain aluminum alloys. While this technology offered a potential sustainable new future for aluminum production, it has been held back by several key limitations.

The first is speed; because LPBF draws out parts in metal powder one layer at a time with one or more tightly focused laser beams, it is a relatively slow and expensive process. This has largely limited its use to higher value parts in the aerospace industry. Additionally, LPBF is currently limited to processing aluminum alloys containing higher levels of silicon, such as AlSiioMg, which helps reduce the melting temperature of the material so it is fluid enough to be processed with a laser. However, these AlSi alloys are also softer and less strong. Most of the high-strength aluminum alloys such as 2000, 6000, and 7000 series are hardly processable by LPBF because they are susceptible to cracking as the material repeatedly heats and cools during the laser printing process. Furthermore, the microstructure of aluminum parts produced with LPBF often shows undesirable grain structures which can affect the resulting mechanical properties. Other high energy welding or melting additive manufacturing procesess such as electron beam additive manufacturing or electron beam melting (EBM) suffer from similar difficulties.

Another potential pathway to successful 3D printing of high-strength aluminum, also developed in the early 1990s, could overcome those obstacles but has its own challenges. Binder jetting technology (BJT), originally developed at the Massachusetts Institute of Technology in the 1990s, uses an inkjet printhead to selectively deposit binder onto metal powders in a bed at high speeds in a layer by layer process. During the binder jetting process, metal powder is bound together at low temperatures to form a bound aluminum part and later sintered in a furnace to fuse the particles together. BJT could easily overcome the speed limits of LPBF or EMB as it is potentially up to 100 times faster, as well as the need to use high levels of silicon during melt-less part forming. As used herein a “bound” part refers to a part in a precise geometric form in which the particles of metal powder are bound together by a binder but has not been sintered. This may also be referred to as a “green” part.

However, sintering bound aluminum parts has been a well-known challenge in manufacturing. The metal injection molding (MIM) market, a highly mature method developed in the 1970s, had been trying to develop a method to successfully sinter bound metal aluminum for decades. While both MIM, and now BJT, could bind aluminum particles into a precision form, neither had found a way to sinter those parts to high densities while also retaining their geometry.

Aspects of the present disclosure seek to overcome these limitations and provide for the production of high density aluminum parts from green or bound aluminum parts.

### SUMMARY

Certain embodiments of the present disclosure may include a method for producing a densified aluminum part, comprising the steps of forming a green part from build powder and a binder wherein the green part comprises less than 5% by weight of the binder, and wherein the build powder comprises aluminum alloy powder comprising aluminum alloy particles and having an aluminum alloy composition comprising a magnesium content ranging from about 0.5 to about 5 weight % of the aluminum alloy composition, and a densification aid mixed with the aluminum alloy powder in an amount ranging from about 0.1 to about 3.0 weight % of the build powder, wherein the densification aid has an average particle size that is smaller than the aluminum alloy particles. The method may further include densifying the green part by heating the green part under a continuous flow of nitrogen gas of at least 5 SCFH and to a sintering temperature between the solidus and liquid temperature of the aluminum alloy sufficient to promote reaction-assisted super-solidus liquid phase sintering, wherein the densified aluminum part has a density of at least 95%.

In certain embodiments the aluminum alloy may be 6061, the densification aid may comprise tin in an amount ranging from about 0.1 to about 0.5% by weight of the build powder, and the continuous nitrogen flow may be at least 20 SCFH.

Further embodiments of the present disclosure may include a method for producing an aluminum part, comprising the steps of forming a green part by binder jet additive manufacturing from build powder and a binder wherein the green part has a binder content of less than 5% by weight and a density in the range of about 50% to about 65%, and wherein the build powder comprises an aluminum 6061 alloy powder comprising aluminum 6061 alloy particles and having an aluminum alloy composition comprising a magnesium content ranging from about 0.5 to about 2 weight % of the aluminum alloy composition, and a densification aid selected from the group consisting of tin, magnesium, copper, and silver mixed with the aluminum alloy powder in an amount ranging from about 0.1 to about 3.0 weight % of the build powder, wherein the densification aid has an average particle size that is sized to substantially reside in interstitial spaces of the aluminum alloy powder. The method may also include the step of densifying the green part by heating the green part under a continuous flow of nitrogen gas of at least 20 SCFH and to a temperature between the solidus and liquid temperature of the aluminum alloy sufficient to promote reaction-assisted super-solidus liquid phase sintering, wherein the aluminum part has a density of at least 95%.

Embodiments of the present disclosure may include a green part comprising build powder bound together with a binder in a fixed relationship and in a predetermined geometry, wherein the binder content of the green part is less than about 5% by weight, wherein the density of the green part ranges from about 50% to about 65%, and wherein the build powder comprises aluminum alloy particles having an aluminum alloy composition comprising a magnesium content ranging from about 0.5 to about 5 weight % of the aluminum alloy composition, wherein the aluminum alloy particles are bound together with the binder forming interstitial spaces between adjacent aluminum alloy particles, and a densification aid in the interstitial spaces wherein the densification aid is present in an amount ranging from about 0.1 to about 3.0 weight % of the build powder, and wherein the densification aid has a particle size to reside in interstitial spaces.

In certain embodiments the densification aid maybe selected from the group consisting of tin, magnesium, copper, silver, and combinations thereof. In further embodiments the aluminum alloy may be a 6XXX series alloy or may include 6061. Still further, the particle sizes of the aluminum alloy particles may range from about 20 microns to about 75 microns.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments are described with reference to the following drawings, in which:

FIG. 1 is a flow diagrams of a method for producing a densified aluminum part according to at least one embodiment of the present disclosure; and

FIG. 2 is a flow diagram of a method for producing an aluminum part according to at least one embodiment of the present disclosure.

### DETAILED DESCRIPTION

Some embodiments of the present disclosure are described in this section in detail sufficient for one skilled in the art to practice the present disclosure without undue experimentation. It is to be understood, however, that the fact that a limited number of embodiments are described in this section does not in any way limit the scope of the present disclosure as set forth in the claims.

It is to be understood that whenever a range of values is described herein, i.e. whether in this section or any other part of this patent document, that the range includes the end points and every point therebetween as if each and every such point had been expressly described. Unless otherwise stated, the words “about” and “substantially” as used herein are to be construed as meaning the normal measuring and/or fabrication limitations related to the value or condition which the word “about” or “substantially” modifies. Unless expressly stated otherwise, the term “embodiment” is used herein to mean an embodiment of the present disclosure.

Aspects of the present disclosure are directed to the production of a high density aluminum part from a green aluminum part—simply referred to as a green part. In certain embodiments, the production of high density aluminum parts is produced by forming a green part using binder jet printing from a build powder with a densification aid and heating the green part under a continuous high flow of nitrogen gas for a time and at a temperature sufficient for aluminum powder in the green part to reach a state of solidus and sinter together.

The green part may be formed from a binder jet printing process. Binder jet three-dimensional printing (BJP) involves the spreading of a layer of a particulate material upon a vertically indexible build platform and then selectively inkjet-printing a fluid onto that layer to cause selected portions of the particulate layer to bind together. The indexible build platform is lowered and the sequence is repeated for additional layers until the desired part has been constructed. The material making up the particulate layer is often referred as the “build powder” or the “build material” and the jetted fluid is often referred to as a “binder”, or in some cases, an “activator”. During the process, the portions of the powder layers which are not bonded together with the binder form a bed of supporting powder around the article or articles which are being made, i.e. a “powder bed” or “build bed.” Suitable binder jet three-dimension printers include the commercially available printers from The ExOne Company.

The build powder used to produce the green parts includes a combination of the selected aluminum alloy powder having magnesium as an alloying component and a densification aid.

In certain embodiments the aluminum alloy powder contains an appreciable amount of magnesium as an alloying component. In some embodiments, the magnesium content may range from about 0.5 to about 5 weight % magnesium. Examples of suitable alloys may include, but are not limited to, 5XXX and 6XXX series alloys, and 6061 in particular.

The particles size of the aluminum alloy powder is not particularly limited and may range from 2 microns to about 75 microns, for example, 20 microns to about 75 microns. As used herein “microns” or “urn” refer to the unit of micrometers. Without intending to be bound by theory it is thought that the surface oxide layer on the aluminum alloy powder particles inhibits the sintering and densification process. Using larger aluminum particle sizes reduces the relative amount of surface aluminum oxide due to the lower overall surface area compared to smaller particle sizes. In some embodiments, aluminum alloy powder may have an average particle size ranging from about 20 mircons to about 75 microns and including in the range from about 20 microns to about 63 microns. Additional modes of particle distribution may be provided, including but not limited to bimodal and trimodal particle distributions. At least one of the modal particle distributions is in the range of about 20 microns to about 75 microns.

A densification aid is mixed in with the aluminum alloy powder, for example, prior to forming the green part. In certain embodiments, the densification aid is a particulate material. The densification aid and the aluminum alloy powder are blended together and then used for the build powder in forming the green part. For binder jet printing, the build powder would be loaded in a powder hopper on the printer and then distributed in a layer by layer process during the binder jet printing process.

The densification aid is an additive that when heated along with the aluminum alloy powder, aids in the densification of the green part through a reaction-assisted super-solidous liquid phase sintering process. Without intending to be bound by theory, it is believed that the densification aid plays a role in the reaction assisted aspect, and/or the super-solidous liquid phase aspect of the sintering process. For the reaction assisted aspect, the densification aid serves to alter and break down the composition of the surface oxide layer of the aluminum alloy particles, such as in the case of spinel formation with magnesium (Mg). For the super-solidous liquid phase sintering aspect, the densification aid serves as a liquid bridge to promote diffusion by going liquidous before other elements in the prealloyed powder. Tin (Sn) for instance would aid in the supersolidous sintering aspect in this fashion. In some embodiments, the densification aid may include particles of tin (Sn), magnesium (Mg), copper (Cu), silver (Ag) or combination thereof. It is believed that these two functions of the densification aid(s) work in tandem to promote sintering to high density greater than about 95% dense, in some embodiments greater than about 97% dense, and in still further embodiments greater than about 99% dense. In certain embodiments, then densification aid goes liquidous before the base alloy and provides a liquid bridge for diffusion of the base aluminum in conjunction with the reaction-assisted portion of the sintering process.

The average particle size of the densification aid is smaller than the largest average particle size distribution of particles making up the aluminum alloy powder. The average particle size of the densification aid, or densification aid particles, can be sized to substantially reside in the interstitial spaces of the aluminum alloy powder of the green part. In certain embodiments, the average particle size of the densification aid particles are sized to reside wholly within the interstitial spaces of the aluminum alloy powder of the green part. The amount of the densification aid making up the build powder may vary but should be sufficient to increase the density of the green aluminum part to above about 95%, for example, to above about 97%, and in some embodiments, and above about 99%, when compared to the selected aluminum alloy density when used with the process of the present disclosure. In certain embodiments, the densification aid may be present in the build powder or green part in an amount ranging from about 0.1 to about 3% by weight (wt %) of the build powder. In some embodiments, the densification aid may be tin (Sn) particles added to the build aluminum alloy powder in an amount ranging from about 0.1 to about 0.5 weight % of the build powder and in some embodiments from 0.25 to about 0.5 weight % of the build powder.

As referenced above, the build powder containing the aluminum alloy powder and the densification aid are loaded in the hopper of the binder jet printer for distribution on the powder bed during the printing process. In an effort to potentially reduce additional formation of oxides on the surface of the build powder and to reduce potential hazards such as explosion risks due to handling fine powders or reactive powders, the printing process may occur under an inert atmosphere, such as, nitrogen gas.

The binder used during the printing process is not particularly limited and may include any of the known binders used in the industry for binding aluminum alloy powders together. The binder can be an organic binder that decomposes or burn out of the green part under 600 C. Suitable binders may include but are not limited to organic based binders such as phenolic, polyester, polyamide, polyesteramide, and polyvinylpyrrolidone based binders. The green part contains less than 5% by weight binder, for example, less than about 3% binder by weight. The printed green part is generally porous and exhibits a density in the green state ranging from about 50% to about 65%. The density percentage refers to the density of the part relative to the theoretical or true density of the material for the respective solid part.

Once the green aluminum part has been printed using a binder jet printing process, the green aluminum part will be contained, i.e. buried, within the powder bed of the build box. Depending on the binder, the part may not have sufficient strength to be handled or survive removal from the powder bed without breaking. Typically the binder is allowed to cure to a degree that the printed part may be removed from the powder bed without breaking.

For many organic or polymer based binders, the time required for curing may be reduced through heating. If a curing step is required, it may be cured under an inert atmosphere, such as, for example, under nitrogen. Curing temperatures and conditions may vary based on the binder system used. Curing at 120 C for 5 hours is often sufficient to cure most organic or polymer based binders. This time and temperature is not critical and may vary depending on a variety of variables including but not limited to the binder system as well as the size and geometry of the green aluminum part.

When the green part has reached a sufficient strength for it to be removed the powder bed, the green part is removed from the powder bed and depowdered to remove any loose or unbound powder that is not part of the green part. In certain embodiments, this process can be performed under an inert atmosphere such as nitrogen.

Once the green part has been depowdered, the green part is subjected to a binder burnout and then a sintering process. The sintering process involves heating the green part under a continuous high flow of nitrogen gas for a time and at a temperature sufficient for aluminum powder in the green part to reach a super-solidus state, sinter together and produced a high density aluminum part.

It is important that the heating step is conducted under a continuous high flow of nitrogen gas. The atmosphere surrounding the green part should be primarily composed of nitrogen with no appreciable amount of oxygen. The continuous high flow of nitrogen flow over the green part should be at least about 5 SCFH (standard cubic feet per hour) and may go up to about 80 SCFH or greater. As the flow rate of nitrogen increases, the economics of producing the part may become more undesirable. In some embodiments the continuous high flow of nitrogen may be at least about 10 SCFH, still other embodiment greater than about 20 SCFH, and in additional embodiments greater than about 40. In some embodiments, the continuous flow of nitrogen may range from about 5 SCFH to about 40 SCFH. Using the process of the present disclosure, densities of 95% or greater are obtained, and in additional embodiment at least about 97%. Surprisingly, the high densities of 99% or greater required the use of a continuous high flow of nitrogen over the green parts during sintering. Other common sintering atmospheres, such as argon, hydrogen, or mixture of nitrogen and hydrogen were not effective at achieving densities of 99% or greater.

Any furnaces that can support the continuous high flow of nitrogen over the green part during the sintering process may be used. Suitable furnaces may include tube furnaces or continuous furnaces.

During the heating step under the continuous high flow of nitrogen gas, the temperature is increased to a temperature sufficient to chemically break down, volatilize, burn out or otherwise remove most of the binder from the green part, or in certain embodiments, remove substantially all of the binder from the green part. This temperature or temperature range may vary depending upon the binder system used. For most binders discussed above, binder removal or burn out is effective within the range of about 470 C to about 560 C. In at least one example, for green aluminum parts, substantially all the binder or binder residue should be removed from the green part prior to reaching a temperature of 600 C. The time required for substantially all the binder from the green part to be removed may vary based on the composition of the binder system, size and geometry of the green part, and selected temperature or temperature range. The green part should have substantially all of the binder removed before elevating the temperature to induce sintering of the aluminum alloy particles of the aluminum alloy powder. Removing substantially all of the binder from the green parts refers to leaving only minor amounts of residual binder or binder residue, if any, so as not to substantially affect the chemical composition of the aluminum alloy or resulting mechanical properties.

During the heating step, the temperature of the green part is raised to a sintering temperature above the solidus temperature and below the and liquid temperature of the base alloy, to promote a reaction-assisted super-solidous liquid phase sintering at a temperature sufficient for the bound aluminum alloy particles from the aluminum alloy powder used to form the green part to begin to fuse together through necking and start to sinter together. The objective of this portion of the heating step is for substantially all of the aluminum alloy particles in the green part to form true metallic bonds through the process of diffusion by reaction-assisted super solidous liquid phase sintering. As used herein, solidus is the highest temperature at which the alloy is still considered a solid but right on the edge of where transient liquid phases begin to exist. In this reaction-assisted super-solidus state, densification aids work with adjacent alloy particles in the green part to promote diffusion and neck together, resulting in a highly dense metal part without ever truly reaching a fully liquid state in the base alloy.

As discussed above, the reaction-assisted portion refers to the components in the system such as magnesium (Mg), whether in the prealloyed powder or added as a densification aid, which play a role in altering the composition of the oxide to promote aluminum diffusion. The super-solidous liquid phase sintering portion, refers to the role of the densification aid, such as tin (Sn), which go liquidous before the base alloy and provide a liquid bridge for diffusion of the base aluminum in conjunction with the reaction-assisted portion.

The sintering temperature or sintering temperature range in the heating step includes the temperature which allows for the activation of the reaction-assisted and super-solidous aspects of the densification aids, while also remaining below the fully liquid point of the base aluminum alloy. Maintaining the sintering temperature above the solidus point but below the fully liquid point is important to retain geometry of the printed part, maintain edge control of the part, and minimize distortions and slumping of the geometry of the part. As an appreciable amount of the aluminum alloy particles move to the liquid state, deformities, slumping, distortions, and other non-desirable effects will be magnified. For the build powder containing aluminum alloy powder used in the present disclosure, the sintering temperature may range from about 610 C to about 660 C and in some embodiments from about 620 C to about 650 C, and in other embodiments about 645 C.

The time required for heating the green part may vary based on the selected sintering temperatures as well as the size and geometry of the green part. The time should be long enough that substantially all the aluminum alloy particles of the green part have had sufficient time to diffuse at the required temperature between the solidus and liquid points of the base alloy and form metallic bonds through the process of diffusion by reaction-assisted super solidous liquid phase sintering. The amount of time is variable and may take several hours. The printed part should remain at the selected sintering temperature for a time sufficient for the part to densify to at least about 95%, in some embodiments at least about 97%, and in certain embodiments at least about 99% when compared to the density of the aluminum alloy powder.

At this point in the process, the densification aid will have been absorbed by the aluminum alloy particles, although in some embodiments it will form intermetallics at the resultant grain boundaries. Without intending to be bound by theory, it is thought that the densification aid in conjunction with the continuous flow of nitrogen gas facilitates in breaking the surface oxide layer of the aluminum alloy particles and promotes the necking and fusion of adjacent aluminum alloy particles in the part.

In certain embodiments, the heating step may utilize more than one temperature where the temperature of the part is raised to an initial temperature followed by one or more temperature increases to remove the binder, followed by one or more additional temperature increases to bring the aluminum alloy particles to the sintering temperature and the green part to a super-solidus state. In the case of a continuous furnace, the printed part may be moved through different temperature zones that increase the temperature of the green part as described above.

Without intending to be limiting, the following example illustrates and embodiment of the present disclosure.

### Example

An aluminum powder with a base alloy of 6061 having a particle size distribution of 20-63 um was used as the build powder. Tin was mixed with the aluminum build powder between 0.25 and 0.5 weight %. Test parts were printed on an ExOne Innovent+ under a nitrogen atmosphere. The green printed parts were cured under nitrogen at 120 C for 5 hours. After curing, the green parts were depowdered under a nitrogen atmosphere.

A tube furnace and a continuous furnace were used to sinter the printed green parts. The parts were sintered under a continuous flow of nitrogen. The flow of nitrogen was about 20 SCFH. Binder burnout was achieved in the range of 470-560 C and the parts were sintered at 645 C.

Densities of the parts reached 97% for parts sintered in the tube furnace, and densities above 99% were achieved through sintering in the continuous furnace. Microstructures were found in both cases to show a super-solidous sintering mechanism. The sintered parts showed uniformity of densification and excellent edge control of the printed part.

The process was repeated on 10 printed coupons using the continuous furnace. As shown in the table below, all values for the coupons were above 99% dense.

| Coupon | % Density |
|---|---|
| 1 | 99.27 |
| 2 | 99.22 |
| 3 | 99.32 |
| 4 | 99.51 |
| 5 | 99.27 |
| 6 | 99.42 |
| 7 | 99.19 |
| 8 | 99.38 |
| 9 | 99.31 |
| 10 | 99.14 |

Archimedes Density of 6061 aluminum compared to the reported powder density of 2.71 g/cc.

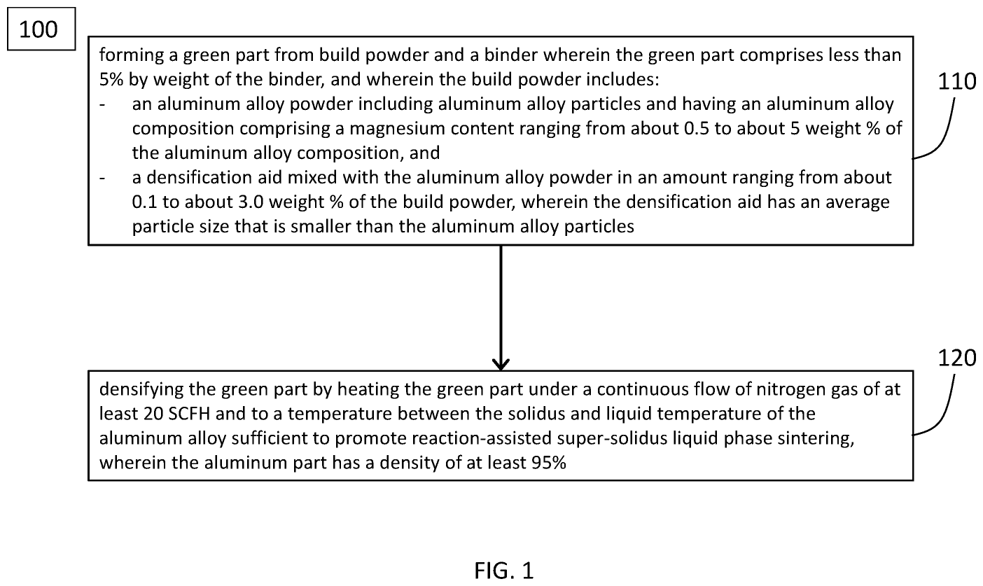

FIG. 1 shows a method 100 for producing a densified aluminum part according to at least one embodiment of the present disclosure. The method 100 includes at 110, forming a green part from build powder and a binder wherein the green part comprises less than 50% by weight of the binder, and wherein the build powder includes:
aluminum alloy powder including aluminum alloy particles and having an aluminum alloy composition comprising a magnesium content ranging from about 0.5 to about 5 weight % of the aluminum alloy composition, and
a densification aid mixed with the aluminum alloy powder in an amount ranging from about 0.1 to about 3.0 weight % of the build powder, wherein the densification aid has an average particle size that is smaller than the aluminum alloy particles.

The method 100 further includes at 120, densifying the green part by heating the green part under a continuous flow of nitrogen gas of at least 5 SCFH and to a sintering temperature between the solidus and liquid temperature of the aluminum alloy sufficient to promote reaction-assisted super-solidus liquid phase sintering, wherein the densified aluminum part has a density of at least 9500.

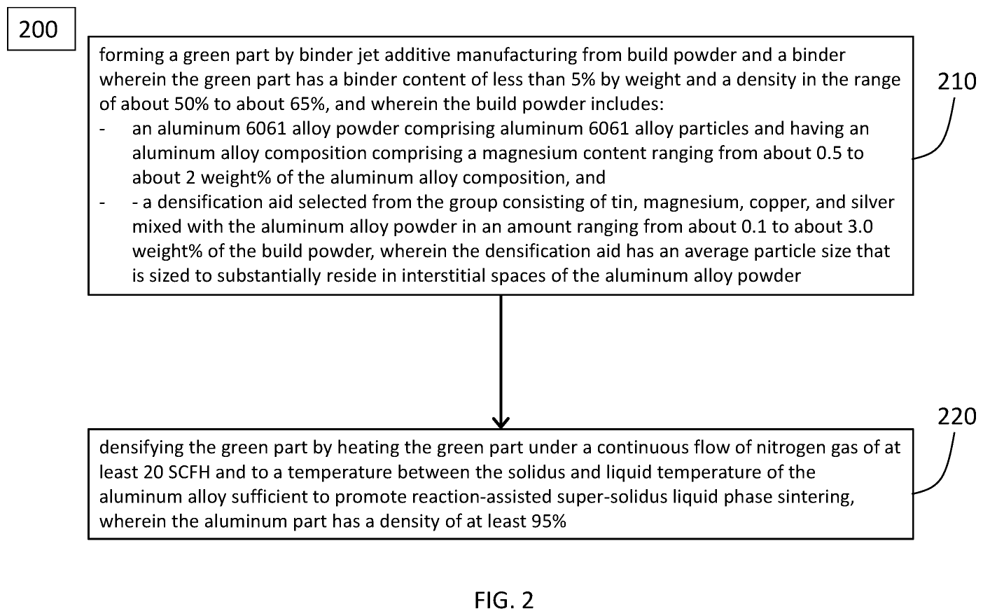

FIG. 2 shows a method 200 for producing an aluminum part according to at least one embodiment of the present disclosure. The method 200 includes at 210, forming a green part by binder jet additive manufacturing from build powder and a binder wherein the green part has a binder content of less than 5% by weight and a density in the range of about 50% to about 65%, and wherein the build powder includes:
an aluminum 6061 alloy powder comprising aluminum 6061 alloy particles and having an aluminum alloy composition comprising a magnesium content ranging from about 0.5 to about 2 weight % of the aluminum alloy composition, and
a densification aid selected from the group consisting of tin, magnesium, copper, and silver mixed with the aluminum alloy powder in an amount ranging from about 0.1 to about 3.0 weight % of the build powder, wherein the densification aid has an average particle size that is sized to substantially reside in interstitial spaces of the aluminum alloy powder.

The method 200 further includes at 220, densifying the green part by heating the green part under a continuous flow of nitrogen gas of at least 20 SCFH and to a temperature between the solidus and liquid temperature of the aluminum alloy sufficient to promote reaction-assisted super-solidus liquid phase sintering, wherein the aluminum part has a density of at least 95%.

While only a few embodiments of the present disclosure have been shown and described, it will be obvious to those skilled in the art that many changes and modifications may be made thereunto without departing from the spirit and scope of the disclosure as described in the claims.

What is claimed is:

1. A method for producing a densified aluminum part, comprising:
forming a green part from build powder and a binder wherein the green part comprises less than 5% by weight of the binder, and wherein the build powder comprises:
aluminum alloy powder comprising aluminum alloy particles and having an aluminum alloy composition comprising a magnesium content ranging from about 0.5 to about 5 weight % of the aluminum alloy composition; and
a densification aid mixed with the aluminum alloy powder in an amount ranging from about 0.1 to about 3.0 weight % of the build powder, wherein the densification aid has an average particle size that is smaller than the aluminum alloy particles; and
densifying the green part by heating the green part under a continuous flow of nitrogen gas of at least 5 standard cubic feet per hour (SCFH) and to a sintering temperature between the solidus and liquid temperature of the aluminum alloy sufficient to promote reaction-assisted super-solidus liquid phase sintering, wherein the densified aluminum part has a density of at least 95%.

2. The method of claim 1, wherein the aluminum alloy is a 6XXX series alloy.

3. The method of claim 1, wherein the aluminum alloy is 6061.

4. The method of claim 1, wherein the aluminum alloy powder has an average particle size in the range from about 20 microns to about 75 microns.

5. The method of claim 1, wherein the densification aid is selected from the group consisting of tin, magnesium, copper, silver, and combinations thereof.

6. The method of claim 1, wherein the densification aid is tin.

7. The method of claim 1, wherein the sintering temperature ranges from about 610 C to about 660 C.

8. (canceled)

9. The method of claim 1, wherein the continuous flow of nitrogen ranges from about 5 SCFH to about 40 SCFH.

10. The method of claim 1, wherein the forming step is performed by binder jet additive manufacturing.

11. The method of claim 1, wherein the aluminum alloy is 6061, the densification aid comprises tin in an amount ranging from about 0.1 to about 0.5% by weight of the build powder, and the continuous nitrogen flow is at least 20 SCFH.

12. The method of claim 1, wherein the densified aluminum part has a density of at least 97%.

13. The method of claim 1, wherein the densified aluminum part has a density of at least 99%.

14. The method of claim 1, wherein the density of the green part is in a range of about 50% to about 65%.

15. The method of claim 1, wherein the average particle size of the densification aid is sized to substantially reside in interstitial spaces of the aluminum alloy powder.

16. The method of claim 1, wherein the average particle size of the densification is sized to wholly reside in interstitial spaces of the aluminum alloy powder.

17. A method for producing an aluminum part, comprising:
forming a green part by binder jet additive manufacturing from build powder and a binder wherein the green part has a binder content of less than 5% by weight and a density in the range of about 50% to about 65%, and wherein the build powder comprises:
an aluminum 6061 alloy powder comprising aluminum 6061 alloy particles and having an aluminum alloy composition comprising a magnesium content ranging from about 0.5 to about 2 weight % of the aluminum alloy composition; and
a densification aid selected from the group consisting of tin, magnesium, copper, and silver mixed with the aluminum alloy powder in an amount ranging from about 0.1 to about 3.0 weight % of the build powder, wherein the densification aid has an average particle size that is sized to substantially reside in interstitial spaces of the aluminum alloy powder; and
densifying the green part by heating the green part under a continuous flow of nitrogen gas of at least 20 standard cubic feet per hour (SCFH) and to a temperature between the solidus and liquid temperature of the aluminum alloy sufficient to promote reaction-assisted super-solidus liquid phase sintering, wherein the aluminum part has a density of at least 95%.

18. The method of claim 17, wherein the aluminum part has a density of at least 97%.

19. The method of claim 17, wherein the densification aid is tin in an amount ranging from about 0.1 to about 0.5 weight % of the build powder.

20. The method of claim 17, wherein the aluminum 6061 alloy particles have an average particle size ranging from about 20 microns to about 75 microns.

21. The method of claim 17, wherein the densification aid has an average particle size that is sized to wholly reside in interstitial spaces of the aluminum alloy powder.
